(19) United States
(12) Patent Application Publication
(10) Pub. No.: US 2026/0184562 A1
(43) Pub. Date: Jul. 2, 2026

(54) METHOD AND DEVICE FOR OBTAINING HIGH-PURITY HYDROGEN FROM METHANOL OR AMMONIA

(71) Applicant: BASF CATALYSTS GERMANY GMBH, Hannover (DE)

(72) Inventors: Carsten HENSCHEL, Hannover (DE); Otto MACHHAMMER, Ludwigshafen am Rhein (DE)

(21) Appl. No.: 19/140,453

(22) PCT Filed: Dec. 20, 2023
(86) PCT No.: PCT/EP2023/086965

§ 371 Date: Jun. 18, 2025

(30) Foreign Application Priority Data
Dec. 21, 2022 (EP) 22215256.3

(51) Int. Cl. C01B 3/3231; B01D 53/04; B01D 53/047; C01B 3/047; C01B 3/56; H01M 8/0606

(52) U.S. Cl. CPC C01B 3/3231; B01D 53/0462; B01D 53/047; C01B 3/047; C01B 3/56; H01M 8/0606; B01D 2256/16; B01D 2257/102; B01D 2257/504; C01B 2203/0227; C01B 2203/0277; C01B 2203/042; C01B 2203/067; C01B 2203/0827; C01B 2203/1223; C01B 2203/1294

(57) ABSTRACT

A method for obtaining hydrogen from methanol or ammonia. First, methanol or ammonia is evaporated. Second, the methanol or ammonia is reformed in order to form a hydrogen-containing gas mixture. Third, the gaseous reformate is cooled. Fourth, the hydrogen is separated from the cooled gaseous reformate by means of a sorption process. Fifth, in parallel with the first four steps, air is compressed and preheated. Sixth, the adsorbent loaded with the extract is regenerated. Seventh, the extract separated from the adsorbent, the tail gas, is combusted with the air. The combustion gases are passed in the direction of flow of the combustion gases through at least two different heat exchangers in order to (i) reform the methanol or the ammonia, (ii) evaporate the reformer feed, and (iii) provide a regeneration process.

The present invention relates to a method for obtaining hydrogen from methanol or ammonia. The invention is characterized in that in a first step, methanol or ammonia is evaporated; and in a second step, the methanol or ammonia is reformed in order to form a hydrogen-containing gas mixture; in a third step, the gaseous reformate is cooled to 25 to 100° C.; in a fourth step, the hydrogen is separated from the cooled gaseous reformate by means of a sorption process at a pressure of 1 to 60 bar and at a temperature of 25 to 100° C.; wherein, in a fifth step, in parallel with the first four steps, air is compressed and preheated; in a sixth step, the adsorbent loaded with the extract is regenerated using the preheated ambient air; and in a seventh step, the extract separated from the adsorbent, the tail gas, is combusted with the air. The combustion gases are passed in the direction of flow of the combustion gases through at least two different heat exchangers in order to (i) first provide the reaction heat for reforming the methanol or the ammonia, and (ii) subsequently provide the evaporation heat for evaporating the reformer feed. The separated hydro-gen preheats the ambient air for the regeneration process after the sorption process.

Hydrogen offers the desired conditions to become a key factor for the energy supply of the future. The transport sector and industry in particular face the major challenge of becoming more climate-friendly. According to calculations by the Federal Network Agency, approximately 4.3 million tons of hydro-gen will be needed annually in Germany alone in 2045 to achieve climate neu-trality. This corresponds to a thermal output of approximately 144 TWh per year (approval of the scenario framework 2023-2037/2045, Federal Network Agency, July 2022, (https://www.netzausbau.de/Wissen/Aus-baubedarf/Szenariorahmen/de.html). For comparison: today's large-scale plants have a maximum annual production capacity of less than 0.1 million tons of hydrogen. In addition, the feedstock is almost exclusively of fossil na-ture.

In the future, hydrogen will be produced using renewable energies. Since the meteorological conditions in Germany are unfavorable and land availability is limited, these large amounts of hydrogen will probably have to be imported. Preferred hydrogen carriers for long-distance transport are methanol and ammonia. Methanol can also be in the form of the crude condensate. This is a mixture of methanol and reaction water.

What is needed is a technology that can recover hydrogen from methanol or ammonia with high efficiency and at low cost.

In order to use hydrogen in industry as a chemical raw material or in the transport sector in fuel cell applications, the hydrogen must be of very high quality, as impurities have an impact on catalysts and membranes.

Hydrogen is currently mainly produced centrally in steam methane reforming (SMR) production units. If the production site and the recycling site are located far away from each other, hydrogen must be highly compressed (up to 350 bar) and, in rare cases, liquefied in order to transport it to the place where it is needed, for example to a hydrogen filling station, using appropriate transport vehicles. However, the transport of hydrogen by vehicle is uneco-nomical and unecological, as larger hydrogen filling stations would have to be supplied daily by a truck.

In parallel to vehicle transport, a few pure hydrogen pipelines exist. However, in order to be able to supply filling stations with hydrogen on a large scale, a separate, dense hydrogen pipeline network would have to be built, similar to the natural gas network. However, such pipeline networks have very high infrastructure costs and also require complex approval procedures, which is why their realization in the near future seems unlikely.

The electrolysis of water has a very high electricity demand, which must be met on an as-needed basis using the available grid power due to the poor storage capacity of H2 at filling stations and in industry. Since the demand for grid power will almost double in the future if, in addition to today's electricity consumers, the car sector and heat generation are to be purely electric, not only the capacities of wind power and photovoltaics must be expanded many times over, but also the electricity grid must be significantly expanded.

In order to keep the large amount of land and sea space required for this, along with the adverse effects on the environment (this applies in particular to wind turbines), as low as possible, it makes sense to relocate hydro-gen production to regions where the meteorological conditions are much better and the open spaces are much larger than in Germany. There are already efforts to produce this demand for renewable energy in the future in countries that have very favorable conditions for this, such as the MENA (Middle East and North Africa) countries. One example is the world's largest green hydro-gen/ammonia project, NEOM HELIOS in Saudi Arabia.

The production costs for hydrogen are significantly lower in windy and sunny countries than in Germany. In order to take advantage of this cost advantage, transport costs must be low. This requirement is met by the two hydro-gen carriers methanol and, above all, ammonia. So-called liquid organic hydrogen carriers (LOHC) also meet this requirement to a certain extent.

Methanol (MeOH) is a basic chemical produced on a large scale and an excellent energy carrier due to its high energy density of 19.9 MJ/kg. In con-trast to hydrogen, methanol can be transported cost-effectively (O. Machham-mer, “Regenerativer Strom aus Deutschland oder e-Fuels aus Chile: Worauf sollte die zukünftige Mobilität bauen?” [“Renewable electricity from Germany or e-fuels from Chile: What should future mobility be based on?”] Chemie Ingenieur Technik, No. 4, 2021). The existing crude oil transport infrastructure can be used for transport.

Methanol is currently still mainly used as a basic chemical, e.g., to produce formaldehyde, acetic acid, methyl chloride, methyl methacrylate, methyl-amines. Energy balance plays a subordinate role in these processes; the added value of the resulting products is essential.

Ammonia (NH3) is a basic chemical produced on a large scale, e.g., for the production of fertilizer. Ammonia is a good energy carrier; at 18.6 MJ/kg, it has almost the same mass-based energy density as methanol (MeOH) at 19.9 MJ/kg. Ammonia has a boiling point of −33° C. and can be transported at ambient temperature in 10 bar low-pressure containers.

A key feature of energy carriers of the future will be their low carbon footprint. For NH3, in addition to renewably-produced hydrogen (H₂), nitrogen (N2) is also required, which is highly concentrated in the atmosphere at approximately 80% and can therefore be easily extracted via an air separation plant.

In the material utilization of ammonia, e.g., as a fertilizer, which is the main focus today, the energy balance plays a subordinate role. The effect of the fertilizer is what is essential in this context.

Known methods for the separation of N2 and H2 are distillation processes, sorption processes such as pressure swing adsorption (PSA) or temperature swing adsorption (TSA) or a combination of PSA and TSA, as well as membrane processes.

The hydrogen can be made available, for example, at a filling station for refueling fuel cell (FC) vehicles. For this purpose, the hydrogen is compressed to the required pressure of 950 bar for intermediate storage and cooled to the required temperature of −40° C. during refueling.

However, if methanol or ammonia is used as an energy carrier, the energy balance of the process as a whole plays a key role. The method as a whole, from the reforming of methanol or ammonia to the release of H2, should advantageously have low energy losses in order to retain as much of the orig-inally used energy as possible.

The operation of fuel cells (FCs) requires hydrogen with very high purity (>99.99%). The production of hydrogen with the highest purity from methanol or ammonia requires multiple process steps: the evaporation and cleavage of methanol or ammonia and the separation of the high-purity hydrogen from the resulting gas mixture. The thermal energy required for evaporation and cleavage must either be fed externally or provided by burning part of the methanol used, the ammonia used, or part of the reforming products.

The prior art focuses primarily on maximum conversion in the reforming process and optimized hydrogen separation.

Membrane reactors are currently the predominant approach to maxim-izing conversion; and for optimized hydrogen separation, membrane processes or a combination of PSA (pressure swing adsorption) and membrane processes are used.

The disadvantage of using membrane reactors is that reforming and H2 separation must necessarily take place at the same temperature level. In membrane reactors, it is therefore not possible to operate both the reforming process and the separation process in the optimal range. The interplay is always a compromise based on process demands: a lower temperature in the membrane reactor has a positive effect on the energy efficiency, while a higher temperature has a positive effect on the in situ hydrogen separation. Because, for MeOH reforming, H2 is continuously separated out during the reforming process, CO2 accumulates in the reaction mixture. On the other hand, the necessary reaction heat must be fed via the heated reactor walls. High CO2 concentration and hot reactor walls lead to coke deposits. This increases the risk of the membrane becoming blocked. To prevent this, additional water must be added to the reaction, which reduces the energetic efficiency.

Membrane reactors are of great academic interest due to the coupling of reaction and H2 separation in the process design; however, due to the dis-advantages mentioned above, they have so far had little practical significance.

Today's common opinion among experts is that the energy required for reforming has a negative impact on the overall energy efficiency (e.g., Armin Scheuermann, “Flüssiger Wasserstoff, Ammoniak oder LO—C-was spricht für welchen H2-Träger,” [“Liquid hydrogen, ammonia or LOHC-Which H2 carrier has the advantage,”] Chemie Technik, May 17, 2022).

### Methanol:

WO 2004/2616 discloses a method consisting of catalytic methanol reforming at 300 to 500° C. and subsequent H2 separation via pressure swing adsorption (PSA) or with the aid of palladium alloy membranes. The energy for reforming and hydrogen separation is provided by an internal or external energy source, although the option of using the retentate and/or extract of the H2 separation as fuel is not disclosed.

WO 2003/86964 describes a reforming apparatus in which methanol reforming and H2 separation from the reformate are carried out using a palla-dium-based membrane or PSA. Temperatures of 200 to 700° C. are disclosed for the reforming process—and 200 to 400° C. for the methanol reforming process. The retentate from the H2 separation is burned as an energy source. No information is disclosed regarding the wiring of the required heat exchangers. Furthermore, no preheating of the burner air or methanol is described.

### Ammonia:

EP 3,028,990 discloses a method for obtaining a hydrogen/nitrogen mixture by ammonia cracking, wherein in a first step liquid ammonia is evaporated and in a second step the gaseous ammonia is cleaved into hydrogen and nitrogen, preferably in a tubular reactor; and in a third step the reformate consisting of hydrogen, nitrogen and unconverted ammonia is cooled in a countercurrent heat exchanger by preheating the ambient air, in order to then burn it with a part of the reformate, preferably in a catalytic burner, and thus provide the necessary heat for the endothermic reaction of ammonia cracking. The residual heat in the cooled combustion gas is used to evaporate the liquid ammonia. Energy efficiency rates of over 90% are expected for this method. The disadvantage of this method is that the reformate still contains residual ammonia and is therefore not suitable for fuel cell applications. The reformate is therefore only suitable for purely thermal use, e.g., in an internal combustion engine. However, this has a lower efficiency than a fuel cell.

GB 1,079,660 discloses an overall process consisting of catalytic NH3 cleavage and subsequent H2 separation via Pd alloy membranes. A preferred temperature range of 650 and 930° C. for NH3 cleavage is described; preferred pressure ranges are not disclosed. The energy for NH3 evaporation and cleavage is generated electrically.

The disadvantage of using electrical energy for NH3 evaporation and cleavage is that, in the best case, this electricity is generated in the downstream fuel cell with an efficiency of a maximum of 70%. This means that not only must the NH3 evaporation and cleavage as well as the H2 separation and the expensive fuel cell be designed larger than they would be for direct use of the combustion energy of the retentate/extract for NH3 evaporation and cleavage, but also more NH3 is needed due to the loss of efficiency.

WO 2018/235059 A1 discloses a membrane reactor and a method for generating electricity on-board via NH3 cleavage using low-temperature plasma and simultaneous H2 separation with Pd—Ag membranes. Due to the permanent H2 separation, almost complete NH3 conversion is achieved even at low temperatures of 200 to 500° C. and at relatively high pressures of 8 to 10 bar. The cleavage energy is again fed electrically.

WO 02/071451 A2 discloses an H2-generating apparatus for on-board applications. The heart of the system is a compact heat exchanger reactor with many channels. While in one half of the channels NH3 is cleaved into N2 and H2 at 550 to 650° C. on ruthenium nickel catalysts, in the other half of the channels a fuel is catalytically burned to provide the heat for the NH3 cleavage. The reformate from NH3 cracking, which consists mainly of N2 and H2, is converted into electricity in a fuel cell. To protect the fuel cell from unconverted NH3, the process gas is first passed over an adsorber bed. The preferentially acidic adsorbent material is not regenerated on-board, but rather is replaced. It is proposed that the cleavage energy is provided by catalytic combustion of NH3 or, preferably, by catalytic combustion of entrained butane. To start the process, the apparatus must be brought to reaction temperature using power from a battery. The disclosed method is suitable for generating electrical power, but not for generating high-purity hydrogen, e.g., for filling stations, since the separation of N2 and H2 is missing.

L. Lin et al. (L. Lin, Y. Tian, W. Su, Y. Luo, C. Chen and L. Jiang, “Techno-economic analysis and comprehensive optimization of an on-site hydrogen refueling station system using ammonia: hybrid hydrogen purification with both high H2 purity and high recovery,” Sustainable Energy Fuels, vol. 4, pp. 3006-3017, 2020) describes a multi-step method for the production of high-purity H2 from NH3 for an H2 filling station. The results are based on simulations. The article relates to a method having the method steps of catalytic NH3 cleavage at 500° C., separation of the unconverted NH3 in PSA (pressure swing ad-sorption), separation of the N2/H2 gas stream by a combination of PSA and membrane processes, and the compression of the product stream with a purity of 99.97% to a pressure of 900 bar for the filling station pump. 15.5% of the gas stream from the NH3 cleavage is burned to cover the required reaction enthalpy. The large number of separation operations and the fact that the reaction enthalpy for NH3 cleavage is provided by burning the reformate (N2, H2 and unconverted NH3) and not by burning the extract makes the method expensive and leads to the need to lose as little H2 as possible via the retentate.

However, if the entire process chain of evaporation, reforming and H2 separation is considered from the point of view of the highest energetic efficiency and the lowest investment costs, it turns out surprisingly that a combi-nation of reforming and a combination of PSA and TSA for H2 separation as well as the best possible heat integration is more effective in terms of lowest H2 production costs.

What is needed is a method for producing hydrogen with high purity from methanol or ammonia for hydrogen filling stations or for the decentralized supply of industrial applications, which produces hydrogen in a few cost-effective apparatuses and with as little energy loss as possible. Furthermore, a low requirement for expensive materials for the catalysts and adsorbers is advantageous. Furthermore, it is advantageous for the energy efficiency if the incoming and outgoing specific energy flows differ as little as possible.

The present invention relates to a method for obtaining hydrogen from methanol or ammonia. The invention is characterized in that in a first step, methanol or ammonia is evaporated; in a second step, the methanol or ammonia is reformed in order to form a hydrogen-containing gas mixture; in a third step, the gaseous reformate is cooled to 25 to 100° C.; and in a fourth step, the hydrogen is separated from the cooled gaseous reformate by means of a sorption process at a pressure of 1 to 60 bar and at a temperature of 25 to 100° C.; wherein, in a fifth step, in parallel with the first four steps, air is compressed and preheated; in a sixth step, the adsorbent loaded with the extract is regenerated using the preheated ambient air; and in a seventh step, the extract separated from the adsorbent, the tail gas, is combusted with the air. The combustion gases are passed in the direction of flow of the combustion gases through at least two different heat exchangers in order to (i) first provide the reaction heat for reforming the methanol or the ammonia, and (ii) subsequently provide the evaporation heat for evaporating the reformer feed. The reformate preheats the ambient air for the regeneration process in a heat exchanger prior to passing into the sorption step; the separated hydrogen preheats the ambient air for the regeneration process after the sorption process; and/or the combustion gases finally preheat the ambient air for the regeneration process as step (iii).

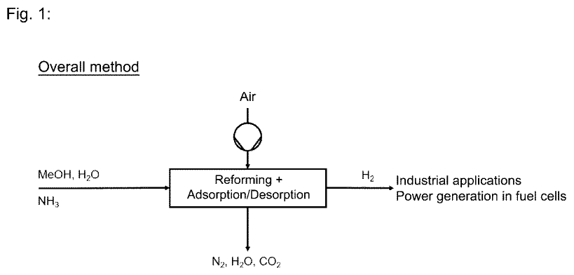

FIG. 1 gives an overview of the overall process of the invention.

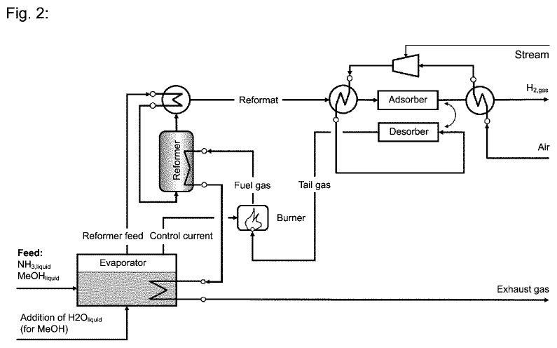

FIG. 2 shows schematically the essential components of the method according to the invention.

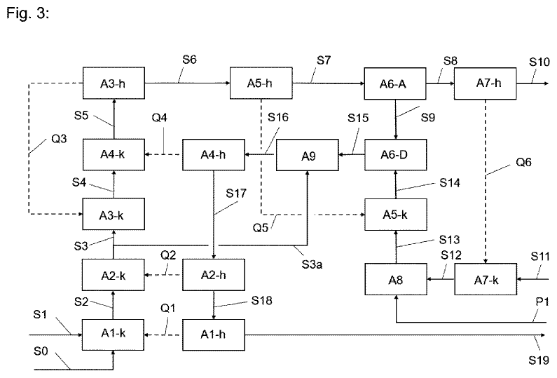

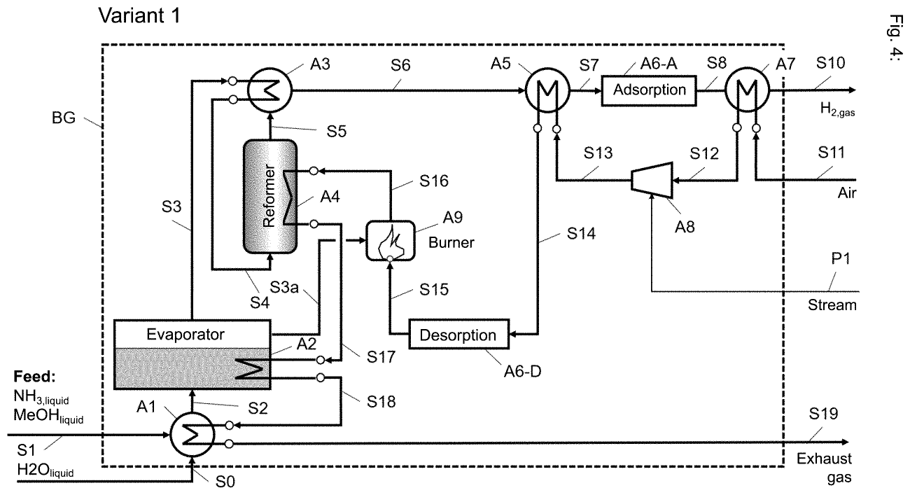

FIG. 3 shows, for the basic case (FIG. 4, variant 1), the designations used below for the streams (S1 to S19), the apparatuses (A1 to A9), and the heat transfer flows (Q1 to Q6). These are also listed in Tables 1 to 4.

TABLE 1
Assignment of the material stream names used in the text with
the material stream designations used in the figures.

| Designation | Material stream names used in the text |
|---|---|
| S0 | Feedstock: water |
| S1 | Feedstock: methanol or ammonia |
| S2 | Feedstock after preheating |
| S3 | Evaporated feedstocks |
| S3a | Control stream |
| S4 | Reformer feed |
| S5 | Hot reformate |
| S6 | Warm reformate |
| S7 | Cold reformate |
| S8 | Warm product stream |
| S10 | Cold product stream (H2 product) |
| S11 | Air supply |
| S12 | Heated air |
| S13 | Compressed air |
| S14 | Heated air |
| S15 | Tail gas |
| S15a | Compressed tail gas |
| S16 | Hot combustion gas from burner with open flame |
| S17 | Warm combustion gas after reformer |
| S18 | Cooled combustion gas after evaporator |
| S19 | Cold exhaust gas |

TABLE 2
Assignment of the apparatus names used in the text to the apparatus
designations used in the figures. Apparatus designations in
the form A1-k, A2-k, etc. always represent the colder stream
side of the corresponding heat ex-changer. Apparatus designations
in the form A1-h, A2-h, etc. always represent the hotter stream
side of the corresponding heat exchanger.

| Designation | Apparatus names used in the text |
|---|---|
| A1 | Preheater Feed |
| A2 | Evaporator |
| A3 | First reformate cooler |
| A4 | Reformer |
| A5 | Second reformate cooler or exhaust gas cooler |
| A6-A | Adsorber |
| A6-D | Desorber |
| A7 | Product cooler and/or air heater |
| A8 | Air conveying element (air compressor, air blower) |
| A9 | Burner |
| BG | Balance limit for the method |

TABLE 3
Assignment of the heat flow names used in the text
to the heat flow designations used in the figures.

| Designation | Heat flow explanations used in the text |
|---|---|
| Q1 | Feedstock preheating |
| Q2 | Evaporation of feedstock by combustion gas cooling |
| Q3 | First Reformate cooling |
| Q4 | Reforming by combustion gas cooling |
| Q5 | Second Reformate cooling |
| Q6 | Cooling H2 product by preheating air |

TABLE 4
Assignment of the names used in the text for turbomachines
to the designations used in the figures.

| Designation | Names for turbomachines used in the text |
|---|---|
| P1 | Mechanical power consumption of the air |
| | conveying element |

The following explanation of FIGS. 3 and 4 refers to the basic case (Variant 1).

### First Step:

The liquid feedstock stream/feed stream S1, which may be an ammonia stream or a methanol stream or a mixed stream of methanol and water, is preferably heated in a preheater A1 (stream S2) and then evaporated in an evaporator A2 to form the reformer feed S3. The heat flows Q1 and Q2 provide these functions. Preheating and evaporation can also be combined in one apparatus (A1+A2).

The designations A1-k and A2-k indicate that these are the cold sides of the heat exchangers A1 and A2, respectively. Accordingly, A1-h and A2-h are the warm and hot sides of the heat exchangers A1 and A2 respectively.

### Second Step:

The reformer feed S3 is advantageously heated in the heat exchanger A3 to create stream S4 before it enters the reformer reactor A4. The heat flow Q3 required for heating is advantageously obtained by cooling the hot reformate stream S5 to create the cooled reformate stream S6.

In the reformer reactor, which is designed as a heat exchanger reactor to introduce the necessary reaction heat Q4, the feed components react to form the hot reformate S5 while absorbing energy.

### Third Step:

Preferably, the cooled reformate stream S6 leaving the heat exchanger A3 is cooled in a heat exchanger A5 to the temperature desired for the adsorption of the secondary components. The resulting heat flow Q5 is preferably used to heat the air S11 required for desorption and combustion. The cooled reformate stream S7 is fed to the adsorption A6-A.

### Fourth Step:

In the adsorption stage A6-A, the secondary components are separated from the hydrogen in the cooled reformate S7 by binding them to a suitable adsorbent. The secondary components bound to the adsorbent are referred to below as extract.

Heat is generated during adsorption. The non-adsorbed hydro-gen leaves the adsorption stage as stream S8, which has a temperature 5 to 100° C. higher than the incoming cooled reformate stream S7 due to the resulting ad-sorption heat. Advantageously, the warm hydrogen stream S8 is cooled in the heat exchanger A7 to form the cooled H2 product stream S10. The resulting heat flow Q6 is advantageously used to preheat the air stream S11.

### Fifth Step:

The air stream S11 is preferably fed from the environment. After the air stream has been advantageously warmed up in the heat exchanger A7 to create the preheated air stream S12, it is advantageously fed to a compressor A8.

This compresses the air to such an extent that all pressure losses can be overcome until the exhaust gas S19 is released into the environment. The advantageously compressed air stream S13 is preferably further heated in the heat exchanger A5 by the heat flow Q5.

### Sixth Step:

The advantageously compressed and heated air desorbs the extract S9 (shown only in FIG. 3) from the sorbent in the desorption stage A6-D. The air stream loaded with the extract is referred to below as the tail gas stream S15. In this step, the loaded absorbent is regenerated.

### Seventh Step:

The combustible components of the tail gas stream S15 are advantageously burned in a burner A9 with the addition of the control stream S3a, to create the hot combustion gas stream S16. The hot combustion gas stream S16 is then advantageously fed to the reformer heat exchanger A4, wherein the hot combustion gas stream S16 cools down to become the warm combustion gas stream S17, mainly to cover the reaction heat Q4 required for the reforming. The warm combustion gas stream S17 is advantageously further cooled in the heat exchangers A1 and A2 in order to heat and evaporate the feed stream S1 with the resulting heat flows Q1 and Q2. The cooled combustion gas leaves the method as the exhaust gas stream S19.

The individual steps are explained in more detail below.

### First Step:

### Methanol:

Methanol and optionally water are fed to an evaporator after heating. Advantageously, the proportion of water is 0 to 75 mol. % with respect to the methanol/water mixture, preferably 10 to 70 mol. %, particularly preferably 25 to 65 mol. %, in particular 40 to 50 mol. %, very particularly preferably a molar ratio of methanol to water of 54:46.

The methanol and/or the methanol/water mixture is advantageously evaporated in an evaporator at pressures between 1 and 60 bar, which are the same throughout the method, adjusted for pressure loss, to form the gaseous reformer feed. The pressure in the evaporator is advantageously between 1 and 30 bar, in particular between 2 and 10 bar. The pressure specifications provide a person skilled in the art with the temperatures required for evaporation.

### Ammonia:

Alternatively, liquid ammonia is taken from a tank, preferably at −35 to 50° C. and 1 to 20 bar, and if necessary, brought to higher pressures by means of a pump. The liquid ammonia is advantageously converted into the gaseous reformer feed in the evaporator at pressures between 2 and 60 bar, which are the same throughout the method, adjusted for pressure loss. Advantageously, the pressure in the evaporator is between 4 and 40 bar, particularly preferably between 6 and 30 bar, in particular between 10 and 20 bar. The pressure specifications indicate to a person skilled in the art the temperatures required for evaporation, advantageously −20° C. to 100° C.

As with methanol, the vaporous NH3 stream is advantageously split into a reformer feed that is fed to the reformer and a control stream that is added to the tail gas stream as required.

### Second Step:

### Methanol:

The reformer feed, i.e., the gaseous methanol or methanol/water mixture, is then catalytically reformed at temperatures between 10° and 400° C. to a gaseous reformate. The methanol reforming temperature is preferably b-tween 180 and 350° C., in particular between 240° C. and 300° C. Low methanol reforming temperatures increase the H2 yield while reducing the CO content due to the WGS equilibrium.

The methanol reformate contains H2, CO, CO2, H2O and unconverted MeOH or DME. The composition of the gaseous methanol reformate preferably consists of 55 to 75 mol. % H2, 1 to 15 mol. % CO, 10 to 25 mol. % CO2, 0.5 to 10 mol. % H2O and 0.1 to 20 mol. % MeOH and/or DME, particularly preferably of 65 to 75 mol. % H2, 6 to 12 mol. % CO, 15 to 20 mol. % CO2, 1 to 5 mol. % H₂O and 0.1 to 5 mol. % MeOH and/or DME.

The reaction yield of the methanol reforming process is advantageously 70 to 99%, preferably 80 to 99%, particularly preferably 85 to 99%.

During the reforming of methanol, the reversal of CO2 hydrogenation takes place:

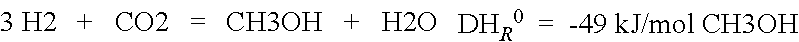

according to the following overall reaction equation:

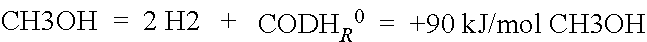

According to the invention, the methanol to be used may also contain proportions of dimethyl ether (C2H6O), typically 1 to 5 wt. %. Dimethyl ether is simultaneously reformed to methanol in the presence of H2O.

Water reacts with CO according to the following overall reaction equation:

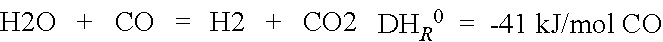

This exothermic reaction is called the water gas shift (WGS) reaction. The water content in methanol can advantageously increase the H2 yield and reduce the additional energy required for the overall process of reforming and WGS.

The maximum CO2 produced in the overall process via WGS reaction and/or combustion of methanol and/or CO corresponds to the CO2 used in the methanol production from CO2 and H2. The method as a whole is therefore CO2 neutral.

Advantageously, no hydrogen stream is withdrawn during the second step, the reforming process. As such, the second step is advantageously a separate step upstream of the H2 separation. Furthermore, the second step is advantageously separate from the first step and downstream of it. The advantageous successive process steps are illustrated in FIG. 3.

Catalysts for reforming methanol are described in the prior art (see, for example, F. Gallucci, et al. “Hydrogen Recovery from Methanol Steam Reforming in a Dense Membrane Reactor: Simulation Study,” Ind. Eng. Chem. Res. 2004, 43, 2420-2432) and A. Basile, et al., “A dense Pd/Ag membrane reactor for methanol steam reforming: Experimental study,” Catalysis Today, 2005, 104, 244-250). For example, CuO/ZnO/Al2O3 mixtures are used as active catalyst components-advantageously with a composition of 38 wt. % CuO, 41 wt. % ZnO and 21 wt. % Al2O3, or mixtures with a composition of 31 wt. % CuO, 60 wt. % ZnO and 9 wt. % Al2O3.

### Ammonia:

Analogous to the case of methanol, the NH3 vapor stream is advantageously fed to a reformer and cleaved there into H2 and N2. The energy required for the cleavage is advantageously covered by a heat flow. Ammonia reforming advantageously takes place at temperatures of 100 to 700° C., preferably 200 to 600° C., in particular between 300° C. and 500° C. Advantageously, the ammonia reforming process takes place at a pressure of 2 to 60 bar, preferably 6 to 30 bar, in particular 10 and 20 bar.

The gaseous ammonia reformate advantageously contains H2, N2 and unconverted NH3 in the following preferred composition: 60 to 75 vol. % H2, 20 to 25 vol. % N2, 0 to 20 vol. % NH3.

The yield of the ammonia reforming process is advantageously 70 to 99%, preferably 80 to 95%, particularly preferably 85 to 95%.

Advantageously, no hydrogen stream is withdrawn during the second step, the reforming process. As such, the second step is advantageously a separate upstream step. Furthermore, the second step is advantageously separate from the first step and downstream of it.

Catalysts for reforming ammonia are described in the prior art (see A. Di Carlo, et al., “Ammonia decomposition over commercial Ru/Al2O3 catalyst: An experimental evaluation at different operative pressures and temperatures,” International. Journal of Hydrogen Energy, 39 (2014) pp. 808-814 or “Ammonia Decomposition on the Process Chain for a Renewable Hydro-gen Supply.” Chemie Ingenieur Technik, 94 (2022), pp. 1-14). For example, ruthenium is used as an active catalyst component-advantageously, ACTA Hyper-mec 10010 catalyst_(Ru/Al2O3). Ni catalysts are particularly active.

### Third Step:

Both the MeOH and the ammonia reformate are then cooled in a gas/gas heat exchanger to the preferred temperature of 25 to 200° C., preferably 35 to 100° C., in particular 40 to 60° C., for H2 separation. In return, the ambient air and optionally also the reformer feed gas are advantageously preheated. The optional heat exchanger for preheating the reformer feed is referred to as A3 below, and the heat exchanger for cooling the reformate with simultaneous preheating of the ambient air is referred to as A5 below.

### Fourth Step:

At a temperature of advantageously 25 to 200° C., preferably 35 to 100° C., in particular 40 to 60° C., the reformate reaches the adsorber bed for the separation of H2.

In the case of both methanol and ammonia, the H2 concentration in the reformate for H2 separation with sorbents is advantageously between 50 and 99 vol. %, particularly preferably between 60 and 95 vol. % and in particular between 65 and 90 vol. %.

In the case of methanol, the CO concentration for H2 separation with adsorbers is advantageously between 0 and 25 vol. %, preferably between 0.5 and 20 vol. % and in particular between 1 and 15 vol. %. A low CO partial pressure is advantageously achieved by the addition of water, a water-gas shift active catalyst and/or low temperatures, preferably 150 to 400° C., in particular 200 to 250° C.

In the event that the CO or CO2 content in the H2 product gas stream does not meet the requirements of the fuel cell, the H2 product gas stream can also advantageously be passed over a methanation catalyst bed (see, for example, WO 2004/002616 A2).

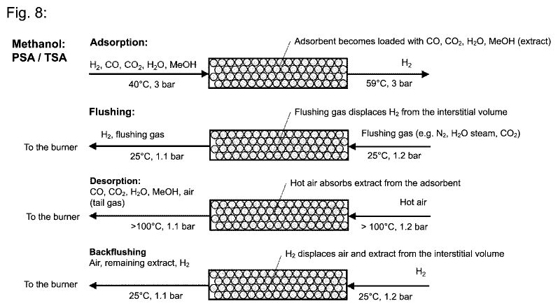

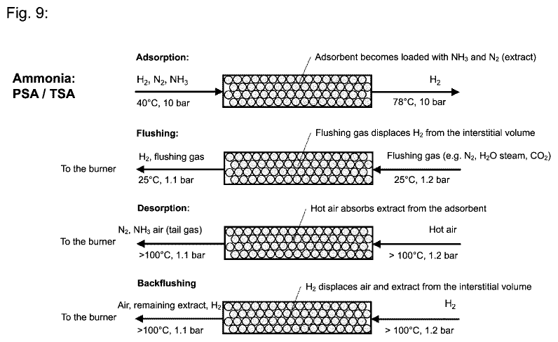

In the adsorber, the gaseous reformate is split into a high-purity H2 product stream, with a purity of preferably >99.99 vol. % H2, and into the extract, which is bound to the solid adsorber (FIGS. 8 and 9, adsorption step). In the case of methanol, the extract consists of CO, CO2, H2O and unconverted MeOH as well as small amounts of H2. When ammonia is used, the extract contains not only N2 but also unconverted NH3 and small amounts of H2. The gas space of the sorption apparatus also contains non-adsorbed H2.

Pressure swing adsorption (PSA) and/or temperature swing ad-sorption (TSA) are preferred adsorption processes; these separation processes are known to the person skilled in the art. In addition, the knowledge of suitable adsorbents for the separation of H2 from gas mixtures that also contain CO, CO2, H2O, N2, MeOH or NH3 is prior art.

In the adsorption step, a gas mixture is typically introduced into a fixed bed reactor filled with the adsorbent at elevated pressure and low temperatures and flows through the packed bed. One or more components of the mixture (referred to here as “extract components”) are adsorbed. At the exit of the bed, the so-called “product component” (in this case, hydrogen) can be re-moved in concentrated form. After a while, the adsorber bed is largely satu-rated and some of the extract components typically escape. At this moment, the process is switched via valves so that the outlet for the product component is closed and an outlet for the extract components is opened. This is accom-panied by a reduction in pressure and—in the case of temperature swing ad-sorption-supported by an increase in the temperature in the fixed bed reactor. At the low pressure and high temperature, the adsorbed gas is then desorbed again and can be recovered at the outlet (see sixth step). For example, two fixed bed reactors filled with adsorbent, which are loaded and unloaded alter-nately, enable continuous operation. In order to expel the residue of desorbed extract component from the adsorber bed, it is advantageous to flush with a portion of the recovered product component to avoid contamination.

The basics of pressure swing adsorption as well as suitable adsorbents for the separation of H2 from CO, CO2, CH4 and H2O-containing gas mixtures can be found, for example, in the following literature (Michael Walter; Druck-wechseladsorption als Wasserstoffreinigungsverfahren für Brennstoffzellen-Systeme im kleinen Leistungsbereich [Pressure swing adsorption as a hydro-gen purification method for fuel cell systems in the small power range]; Dissertation, University of Duisburg-Essen, 2003). This document also describes the overall system of hydrogen reforming and fuel cells. However, the heat integration specified there is based on the use of waste heat by burning the exhaust gases from the downstream fuel cell and not on the combustion of the tail gas resulting from desorption as according to the invention.

Adsorbents for the separation of H2 from N2- and NH3-containing gas streams are described, for example, in WO 02/071451 A2 or in L. Lin et al. (L. Lin, Y. Tian, W. Su, Y. Luo, C. Chen and L. Jiang, “Techno-economic analysis and comprehensive optimization of an on-site hydrogen refuelling station system using ammonia: hybrid hydrogen purification with both high H2 purity and high recovery,” Sustainable Energy Fuels, Vol. 4, pp. 3006-3017, 2020).

L. Lin et al. recommend Zeolite 13 X as an adsorbent for the separation of nitrogen-hydrogen mixtures.

Carbon-containing adsorbents such as activated carbon or carbon mo-lecular sieves and oxidic adsorbents such as zeolites or manganese-magne-sium-aluminum oxides are frequently used. Zeolitic imidazolate structures are also suitable for H2-N2 separation.

### Fifth Step:

Air is advantageously sucked in from the environment and compressed to a pressure that corresponds to the sum of all pressure losses in the gas line starting from the heat exchanger for heating the air until it leaves the system as exhaust gas. The sum of all pressure losses can be in the range from 50 mbar to 5 bar. Air blowers, for example, can be used as compressors.

The compressor can also advantageously be arranged between the desorber and the burner. This has the advantage that a negative pressure is cre-ated in the desorber, which promotes desorption. The higher temperature level would be detrimental to the compressor performance in this arrangement.

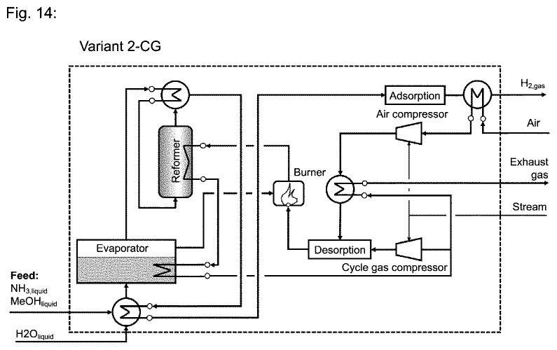

It may be advantageous to recirculate part of the oxygen-depleted exhaust gas using a cycle gas compressor before the desorption stage (see FIG. 14, variant 2-CG) in order to stay below the explosion threshold for hydro-gen of 4 vol. % in air.

### Sixth Step:

The advantageously compressed and heated air, and optionally the cycle gas, desorb the extract from the sorbent at temperatures between 5° and 700° C., preferably at 80 to 600° C. and particularly preferably at 100 to 500° C., in particular between 15° and 400° C., and at pressures between 0.1 and 5 bar, preferably at 0.5 and 3 bar, particularly preferably at 0.9 to 2 bar (FIGS. 8 and 9).

The largely extract-free sorbent is then advantageously flushed with an inert gas. For the first flush, N2, steam and/or CO2 can be used. The cycle gas is also suitable as long as the oxygen concentration is low enough not to form an explosive mixture with the hydrogen used for backflushing. After backflushing, the sorption apparatus only contains largely extract-free sorbent and hydro-gen. The cooled reformate can now advantageously be fed back into these for H2 separation.

During the desorption and flushing processes, a total of 11 to 18% of the product gas (in this case hydrogen) is normally lost. In general, larger flushing gas quantities mean larger hydrogen losses (Thomas Joachim Ried, “Further developed CO2 removal by temperature swing adsorption with indirectly tempered adsorbers”, Dissertation, Technical University of Munich, Aug. 25, 2020, p. 68).

However, the method according to the invention can make it possible to achieve lower flushing losses in the range of 5 to 12 vol. % of the hydrogen in the reformate.

### Seventh Step:

The tail gas from the desorption stage using methanol advantageously has the following gas composition: 0.5 to 5.0 vol. % H2, 10 to 21 vol.% O2, 50 to 80 vol. % N2, 0.1 to 10 mol. % CO, 0.01 to 10 mol. % CO2, 0.01 to 5 mol. % H2O and 0.001 to 1 mol. % MeOH, particularly preferably 1 to 3 vol. % H2, 15 to 20 vol. O2, 70 to 80 vol. % N2, 1 to 5 mol. % CO, 0.02 to 5 mol. % CO2, 0.1 to 1 mol. % H2O and 0.001 to 0.5 mol. % MeOH.

The tail gas from the desorption stage using ammonia preferably contains the following gas composition: 1 to 20 vol. % H2, 1 to 10 vol. % NH3, 40 to 95 vol. % N2, 5 to 20 vol. % O2, particularly preferably 2 to 10 vol. % H2, 2 to 6 vol. % NH3, 60 to 85 vol. % N2, 12 to 19 vol. % O2,

The gas mixture of heated air and desorbed extract is fed to a burner, which advantageously combusts the combustible components in the tail gas, in particular (residual) methanol, carbon monoxide and hydrogen in the case of methanol and (residual) ammonia and hydrogen in the case of ammonia, with the aid of the preheated ambient air in order to cover the required energy for evaporation and reforming, and advantageously for preheating, evaporation and reforming.

If the calorific value of the tail gas is insufficient, a control stream is advantageously drawn from the evaporator and fed to the burner.

The burner can be, for example, an atmospheric burner or a catalytic burner. The hot combustion gas—in the case of an atmospheric burner, advantageously at a temperature of 500 to 1300° C. and in the case of a catalytic burner advantageously at a temperature of 300 to 700° C. —is passed through various heat exchangers in order to provide (i) the reaction heat for the reforming, (ii) the evaporation heat for the evaporation of the methanol or ammonia and, if necessary, (iii) the preheating of the feedstock.

The hot combustion gas is advantageously cooled successively after leaving the burner. The cooling of the combustion gas is advantageously carried out in such a way that the difference between the two sums of incoming and outgoing specific energy flows, based on the calorific value of the hydro-gen product flow, is between 0.1 and 10 kWh/kg hydrogen, preferably b-tween 0.2 and 5 kWh/kg hydrogen, more preferably between 0.5 and 4 kWh/kg hydro-gen, more preferably between 0.8 and 3 kWh/kg hydrogen, particularly preferably between 1 and 2 kWh/kg hydro-gen.

In a preferred embodiment, the energy required for evaporation and reforming can be provided by advantageously feeding methanol or ammonia in liquid and gaseous states to the burner in addition to the tail gas. By feeding methanol or ammonia, the method as a whole can be started up advantageously and controlled in a stable operating state during operation. The ad-mixture into the tail gas can also advantageously take place prior to the burner.

The addition of methanol or ammonia is advantageously controlled via the sensor-detected energy content of the exhaust gas, i.e., the cooled combustion gas leaving the method, and the temperature of the combustion gases from the burner. All this together results in the energy available for evaporation and reforming. If, for example, the burner temperature or the amount of exhaust gas drops, it is advantageous to add methanol or ammonia to the burner. The amount of methanol or ammonia required can vary greatly. The amount of methanol or ammonia fed to the burner is advantageously between 0 and 30%, preferably between 0.01 and 20%, preferably between 0.1 and 15%, in particular between 0.5 and 12% of the amount of methanol or ammonia fed to the overall process.

For methanol, the hot combustion gas produced in the burner when an atmospheric burner is used advantageously has a temperature of 350° C. to 800° C., preferably 400° C. to 700° C., and advantageously has a temperature of 200 to 600° C., preferably 300 to 500° C. when a catalytic burner is used.

For ammonia, the hot combustion gas produced in the burner when an atmospheric burner is used advantageously has a temperature of 600° C. to 1300° C., preferably 700° C. to 1200° C., and advantageously has a temperature of 400 to 700° C., preferably 500 to 600° C. when a catalytic burner is used.

When methanol is used, the combustion gas advantageously contains H2O, CO2, N2 and residual O2. The combustion gas advantageously has the following composition: 10 to 20 vol. % O2, 66 to 80 vol. % N2, 1 to 10 vol. % CO2, 0.1 to 10 vol. % H2O, particularly preferably 15 to 19 vol. % O2, 49 to 77 vol. % N2, 4 to 9 vol. % CO2, 1 to 9 vol. % H2O, in particular 18 vol. % O2, 74 vol. % N2, 5 vol. % CO2, 3 vol. % H2O.

The combustion gas advantageously contains N2, O2 and H2O when ammonia is used. The combustion gas has the following composition, by way of example: 78 vol. % N2, 9 vol. % O2 and 13 vol. % H2O.

In all cases, the composition of the combustion gas is advantageously controlled via the residual O2 concentration. Low O2 values mean low combustion gas volume flows (low compression input), but a high initial temperature of the combustion gas. High O2 values (maximum 21 vol. %) have the opposite effect.

The flow pattern of the combustion gas is shown in FIG. 4 for the basic case (variant 1).

The hot combustion gas advantageously passes successively through multiple heat exchangers, (i) the reforming, (ii) the evaporation of the liquid feedstock, and (iii) optionally the preheating of the ammonia, methanol or methanol-water feed, and is gradually cooled to almost ambient temperature (see FIGS. 2 to 6).

In the catalytic burner, the temperature remains approximately constant over the entire flow path. The temperature on the combustion side is advantageously 1 to 300° C., preferably 5 to 50° C., above the temperature in the reformer (200 to 500° C.) and in the evaporator (130 to 220° C.), i.e., the temperature on the combustion side is 200 to 700° C. in the reformer and 130 to 520° C. in the evaporator.

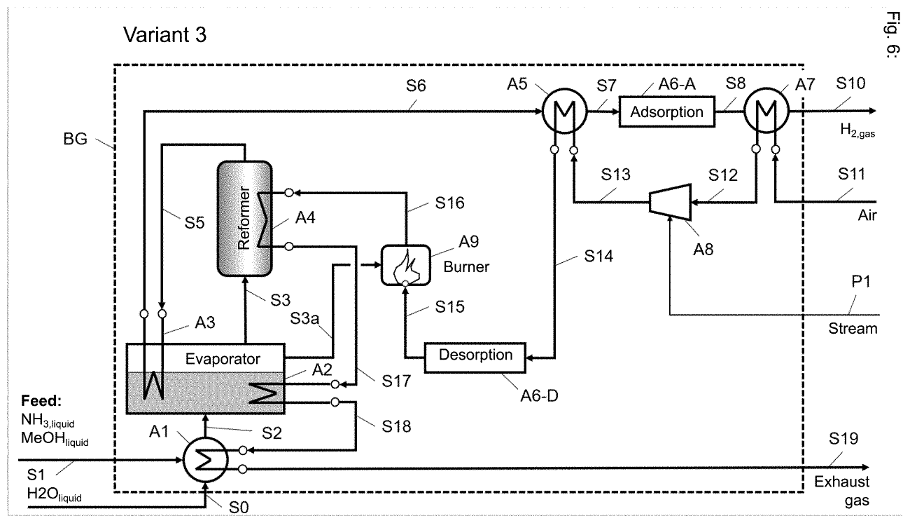

In parallel, the reformate S6, which has a temperature of 200 to 700° C., is advantageously cooled in the heat exchanger A3 by heating the reformer feed S3 (variant 1, FIG. 4). Alternatively, the sensor-detected heat of the reformate S6 can be used to evaporate part of the liquid feed S3 (variant 3, FIG. 6).

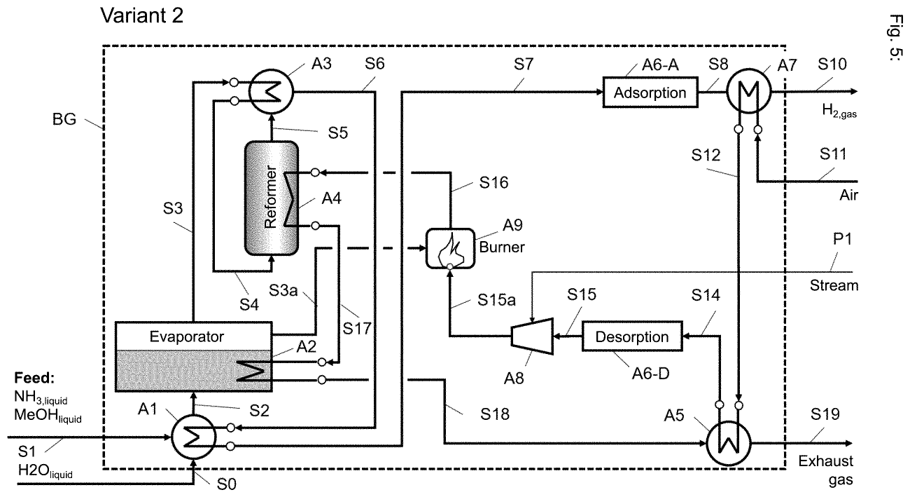

A further advantageous variant is to cool the reformate S6 in the heat exchanger A1 to the desired temperature for adsorption in order to heat the liquid feed S1 and possibly even partially evaporate it (variant 2, FIG. 5).

In variant 1 (FIG. 4), the air sucked in for the burner is advantageously preheated. The reformate is thus cooled down to a temperature difference with respect to the incoming air stream of 1 to 200° C., preferably 2 to 100° C., more preferably 5 to 80° C., more preferably 8 to 50° C., in particular 10 to 40° C. This step is of great importance for the energy efficiency of the reformer module.

In the method, the exhaust gas temperatures can be advantageously controlled via the air stream and/or the combustion gas temperatures. If the combustion gas temperature is too high, the amount of air drawn in is advantageously increased. If the product quantity is too low, the control stream S3a is advantageously increased.

In terms of high energy efficiency, small air flows are better than large ones. However, small air flows result in high combustion gas temperatures, e.g., 1100 to 1200° C. Due to the temperature resistance of the materials used for the heat exchangers and gas lines, the combustion gas temperature can advantageously be limited to 1100 to 1200° C.

For process control, the amount of exhaust gas S19 and the H2 product quantity S10, as well as the temperatures in the gas streams S16, S17 and S18 are preferably measured. The feed stream volume S1 is preferably controlled via the H2 product quantity. The gas temperatures advantageously reg-ulate the intake air stream S11 and the control stream S3a.

Downstream fuel cell:

A further possibility to further increase the overall efficiency of the entire system is to recirculate the offgas from a downstream fuel cell, which may contain unconverted H2, into the burner via desorption in order to use it there for energy production (see variant NH3-2-fuel cell, FIG. 14).

The present invention thus also includes a method for producing electricity from methanol or ammonia, which is characterized in that methanol or ammonia is evaporated in a first step, reformed in a second step to a hydrogen-containing gas mixture, in a third step the gaseous reformate is cooled to 25 to 200° C., in a fourth step the hydrogen and, in the case of ammonia, together with the nitrogen, are separated from the cooled gaseous reformate at a pressure of 1 to 60 bar and a temperature of 25 to 200° C. by a sorption process, and further electricity is produced from the separated hydrogen in a fuel cell, wherein, in parallel to the first steps, air is compressed and preheated in a fifth step, in a sixth step the adsorbent loaded with the extract is regenerated with the offgases from the anode and/or cathode side of the fuel cell, and in a seventh step the extract separated from the adsorbent is combusted with the air, wherein the combustion gases are passed through at least three different heat exchangers in the direction of flow of the combustion gases in order to (i) first provide the reaction heat for reforming the methanol or ammonia and to (ii) then provide the evaporation heat for evaporating the reformer feed, and finally to (iii) preheat the air and/or the extract separated from the adsorbent.

Preferably, the combustion gases are passed through at least four different heat exchangers in order to provide, in the direction of flow of the combustion gases, (i) first the reaction heat for the reforming of the methanol or ammonia, and then (ii) the evaporation heat for evaporating the reformer feed, and then (iii) for preheating the extract separated from the adsorbent, and finally (iv) for preheating the air.

Preferably, in the sixth step, the adsorbent loaded with the extract is regenerated with the offgases of the anode and cathode sides of the fuel cell.

Preferably, the reformate, before entering the sorption step, preheats the feed before the evaporator and/or the reformer feed after the evaporator in a heat exchanger. Particularly preferably, the reformate first heats the reformer feed and then the feed before entering the sorption step.

Preferably, the air required for the burner and the fuel cell is fed via a single compressor.

Ammonia is preferably used as the feed. Suitable adsorbent materials for ammonia contain a salt complex of the 3d transition metals. These materials are preferably manganese, iron, cobalt, nickel, copper, or zinc. Other suitable materials are impregnated activated carbons such as AddsorbTMVB1, a phosphoric acid impregnated activated carbon or zeolite such as Fe/HBEA, e.g., with a silicon to aluminum ratio of 12.5.

### Advantages:

Adsorption processes such as PSA and TSA have the disadvantage that the tail gas produced during the regeneration of the extract-loaded adsorbent contains approximately 11 to 18% of the hydrogen produced (Thomas Joachim Ried, “Further developed CO2 removal by temperature swing ad-sorption with indirectly tempered adsorbers,” Dissertation, Technical University of Munich, Aug. 25, 2020, p. 68) and thus represents a loss. This disadvantage does not occur in the method according to the invention, since the calorific value of the hydrogen in the tail gas can be used to heat the heat-consuming reforming process.

Since-apart from the electrical consumers such as air compressors-no additional energy is fed from outside and no excess energy is released to the outside, the H2 product stream must, in the theoretical limiting case, have the same calorific value as the liquid feedstocks methanol or ammonia. Therefore, theoretically no conversion energy is lost in this method according to the invention. Losses only occur because the discharged streams are warmer than the fed ones and because of heat dissipation via the apparatus walls to the environment as well as due to the mechanical power loss of the air conveying element.

### Analysis Parameters:

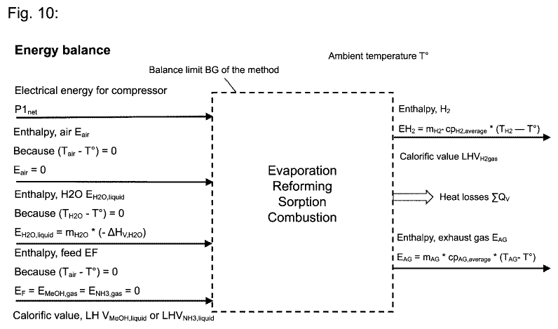

In the method according to the invention, the external energy balance is determined exclusively by the energies stored in the infeed and discharged streams (FIG. 10). For the theoretical ideal case that the fed streams of methanol/water or ammonia as well as air and electricity for air compression import the same output into the process as the discharged streams of H2 product and exhaust gas export, this results in an energy efficiency of 100% for this process.

The energy efficiency can be determined using two approaches, wherein only the second approach can provide instructions for achieving a low energy efficiency:

### First Approach:

In the first approach, the chemical energy content of the feed stream and the H2 product stream are used to determine the energetic efficiency. The chemical energy content can be found from the respective calorific values (LHV=lower heating value) multiplied by the corresponding mass flows.

The chemical energy content of the feed stream E_{F,LHV} is calculated as follows from the mass flow m_{F} and the calorific value LHV_{F}

$${E}_{F , LHV} = {m}_{F} * {LHV}_{F}$$

The energy content of the H2 product stream E_{H2} is calculated accordingly from the mass flow mH2 and the calorific value LHV_{H2}

$${E}_{H 2 , LHV =} {m}_{H 2} * {LHV}_{H 2}$$

The chemical conversion losses ΔE_{V} are the difference between E_{F,LHV} and E_{H2,LHV}

$${ΔE}_{V , chem} = {E}_{F , LHV} - {E}_{H 2 , LHV}$$

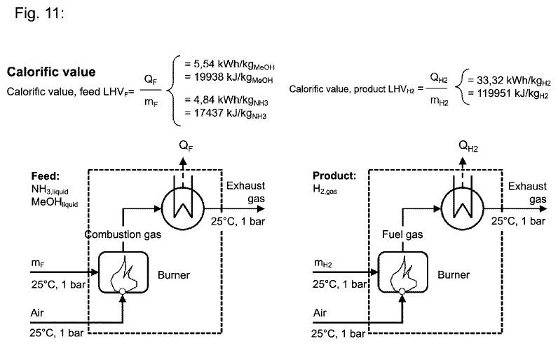

For this approach, knowledge of the calorific values LHV (lower heating value) for the feed (MeOH_{liquid} and NH3_{liquid}) and the product (H2_{gas}) is necessary. These are known from the literature and can be determined as shown in FIG. 11. In addition, the mass flow for the input energy carrier m_{F} and the mass flow for the extracted energy carrier H₂ m_{H2} must be known.

The chemical energy efficiency η_{EN, chem} of the conversion of MeOH or NH₃ to H₂ can then be defined as follows:

$${η}_{EN , chem} = {E}_{H 2 , LHV} / {E}_{F , LHV} = ( {E}_{F , LHV} - {ΔE}_{V , chem} ) / {E}_{F , LHV} = 1 - {Δ E}_{V , chem} / {E}_{F , LHV}$$

For the energy conversion losses ΔE_{V,tot} the gross electrical power P1_{gross} which is input into the method must additionally be taken into account,

$${ΔE}_{V , tot} = {ΔE}_{V , chem} + P {1}_{gross}$$

The energy efficiency EN, tot of the conversion of MeOH or NH₃ to H₂ can then be defined as follows:

$${η}_{EN , tot} = {E}_{H 2 , LHV} / ( {E}_{F , LHV} + Σ {P}_{g r o s s} ) = ( {E}_{F , LHV} - {ΔE}_{V , tot} ) / {E}_{F , LHV} = 1 - {ΔE}_{V , tot} / {E}_{F , LHV}$$

### Second Approach:

In the second approach, the energy flows entering and leaving the process are balanced across the balance boundary of the method to determine the energy efficiency (FIG. 10).

The energy flows in the example calculations are calculated as follows:

$$Gaseous streams : {E}_{gas} = {m}_{gas} * {cp}_{gas , average} * ( T - {T}^{0} )$$

$$Liquid streams : {E}_{liquid} = {m}_{liquid} * {cp}_{gas , averaga} * ( T - {T}^{0} ) = Δ Hv$$

where cp_{gas, average}=average specific heat of the stream for the temperature range between T° and T. T° is the reference temperature and is fixed as 25° C. in the following calculations. The ambient temperature at which the streams enter and exit the balance region of the method is also fixed at 25° C. This has the advantage that no incoming gas flows need to be taken into account, since for these T-T°=0. Rather, only the exiting gas streams that have a higher temperature T than the ambient temperature T° are taken into account. For the incoming liquid water streams, only the evaporation enthalpy of the water Δ_{HV,H2O} need be taken into account, since T−T°=0 also applies here. The evaporation of MeOH and NH3 is taken into account by using the calorific value of the liquid energy carriers LHV_{MeOH, liquid} and LHV_{NH3, liquid} (see FIG. 11). The enthalpies of evaporation Δ_{Hv, MeOH} and ΔH_{V, NH3} are therefore already taken into account in the respective calorific values LHV_{liquid}. The respective energy-car-rying feed streams can then be treated like gas streams and therefore have the value 0.

In the second approach, the conversion losses ΔE_{V} are calculated as follows (see FIG. 10):

$$Δ Ev = outgoing energy flows - incoming energy flows$$

$$Δ Ev = {E}_{H2} + {E}_{EG} + {ΣQ}_{V} - {m}_{H2O} * ( - Δ {H}_{V , H2O} ) - P {1}_{net}$$

$${E}_{H2} = {m}_{H2} * {cp}_{H2 , average} * ( {T}_{H2} - {T}^{0} )$$

$${E}_{EG} = {m}_{EG} * {cp}_{EG , average} * ( {T}_{EG} - {T}^{0} )$$

So that ΔE_{V} is small, in addition to the good heat integration, which is reflected in a small E_{H2} and a small E_{EG}, the flow pressure loss of the combustion gas must be low, the air conveying element must have a high efficiency, and the apparatuses must have good insulation.

For the electrical energy for the compressor P1, of the gross power P_{gross}, only the net power Pₙₑₜ may be taken into account, because only the net output is reflected as an energy component in the product stream. The power loss ΔP_{V}=P1_{gross}−P1ₙₑₜ cannot be used in the surrounding area.

However, for the overall efficiency of the method ηEN, tot, with regard to electrical energy the gross power P1_{gross} must be taken into account. The total energy conversion losses ΔE_{V,tot} are then

$$Δ {E}_{V , tot} = Δ Ev + P {1}_{g r o s s}$$

This results in the overall efficiency of the method ηEN, tot:

$${η}_{EN , tot} = 1 - Δ {E}_{V , tot} / {E}_{F , LHV}$$

and the specific total conversion losses ΔE_{V,spec} related to H2 product mass flow m_{H2}:

$$Δ {E}_{V , spec} = Δ {E}_{V , tot} / {m}_{H2}$$

It can be seen that in terms of small energy conversion losses ΔE_{V,tot} not only should the temperature difference between the outgoing streams and the environment be kept small, but also the corresponding mass flows should be. With a constant H2 product stream, only the exhaust gas stream is af-fected. In addition, the incoming water streams should be kept small and as much heat flow as possible should be used in the method; also, the apparatuses should be well insulated so that the heat loss flows ΣQ_{V} are small. In addition, high mechanical efficiency in the airflow machines reduces the energy conversion losses ΔE_{V,tot}.

Based on this knowledge, the object is to develop a method for the conversion of MeOH and NH3 to hydrogen that has the lowest possible enthalpies for the outgoing streams and does not generate any heat loss flows.

In concrete terms, this means connecting the flows with regard to their heat exchange in such a way that the difference between the two sums of incoming and outgoing specific energy flows, based on the calorific value of the hydrogen product flow, is between 1 and 5 kWh/kg hydro-gen.

The method according to the invention achieves this object. The method according to the invention enables overall energy efficiencies η_{EN, tot} of advantageously 80 to 99%, preferably 90 to 98%. The method according to the invention has total energy conversion losses ΔEv, tot when using methanol of 2 to 8 kWh/kg H2, preferably 2.5 to 4 kg/kg H2, and when using ammonia of 0.5 to 3 kWh/kg H2, preferably 1.0 to 2 kg/kg H2.

Table 5 once again lists the terms in tabular form.

TABLE 5
Assignment of the names used in the text for energy
flows with the designations used in the figures.

| Designation | Names for energy flows used in the text |
|---|---|
| E_{F, LHV} | Calorific value of the feed stream |
| E_{H2, LHV} | Calorific value of the H2 product stream |
| E_{H2} | Sensor detectable heat of the H2 product stream |
| E_{EG} | Sensor detectable heat of the exhaust gas stream |
| ΔE_{V, chem} | Chemical conversion losses |
| ΔE_{V, tot} | Total energy conversion losses |
| ΔE_{V, spec} | Specific total conversion losses related to the H2 product |
| | mass flow |
| ΣQ_{V} | Total heat loss flows |
| E_{gas} | Enthalpy of a gas stream |
| E_{liquid} | Enthalpy of a liquid stream |
| ΔH_{V, H2O} | Evaporation enthalpy of water |
| LHV_{H2} | Lower calorific value of hydrogen (lower heating value H2) |
| LHV_{F} | Calorific value of the feedstocks (lower heating value |
| | MeOH and NH3) |
| m_{H2} | Mass flow of H2 product |
| m_{F} | Mass flow of feedstocks MeOH and NH3 |
| m_{gas} | Gaseous mass flow |
| m_{liquid} | Liquid mass flow |
| cp_{gas, average} | Average specific heat capacity of a gas stream |
| cp_{H2, average} | Average specific heat capacity of the H2 product stream |
| cp_{EG, average} | Average specific heat capacity of the exhaust gas stream |
| T | Temperature of a stream |
| T_{H2} | Temperature of the H2 product stream |
| T_{EG} | Temperature of the exhaust gas stream |
| T⁰ | Reference temperature or assumed ambient temperature |
| P1_{gross} | Electrical power consumption of the compressor |
| P1ₙₑₜ | Mechanical power output of the compressor |
| ΔP_{V} | Compressor power loss |
| η_{EN, chem} | Chemical energy efficiency |
| η_{EN, tot} | Overall efficiency of the method |

### First Example—Methanol

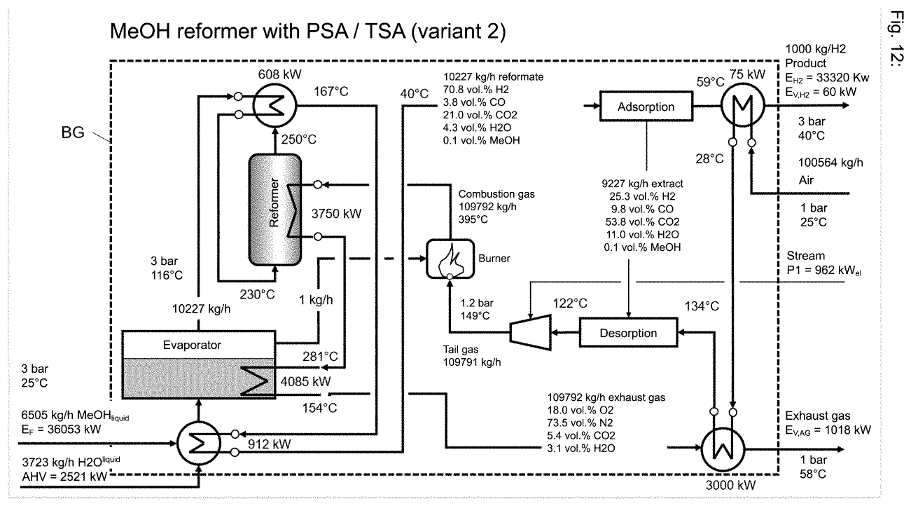

FIG. 12 shows an example of the method according to the invention for the output of 1000 kg H2/h according to variant 2 as determined on the basis of a model calculation.

The example is the result of a thermodynamic simulation with regard to amounts and energies using a BASF internal simulator similar to the simulation program Aspen Plus.

The example is calculated without heat losses through the method apparatus walls.

According to the method according to the invention, 6505 kg of methanol and 3723 kg of water at a temperature of 25° C. and a pressure of 3 bar must be fed into the method per hour.

With a countercurrent flow of the liquid feedstocks and the warm reformate in the second reformate cooler, the liquid feedstock mixture is preheated and the reformate is cooled to the adsorption temperature of 40° C. This requires a heat transfer capacity of 912 KW. The liquid feedstock mixture has a boiling point of 116° C. at 3 bar. 10,227 kg of raw condensate steam are fed to the reformer as the reformer feed, and 1 kg/h are fed to the burner as a control stream.

In the reformer, the raw condensate steam is brought to the reaction temperature of 250° C. and catalytically reformed to 70.8 vol. % H2, 3.8 vol. % CO and 21.0 vol. % CO2. The MeOH equilibrium conversion at 250° C. and 3 bar is theoretically 99.9%. The reformate additionally contains 4.3 vol. % unconverted H2O and 0.1 vol. % unconverted MeOH. 3750 KW of thermal energy is required for the reforming process.

The reformate is then cooled down in the first reformate cooler to 167° C. In return, the vaporous raw condensate is heated from 116° C. to 230° C. The heating requires 608 KW of thermal output.

In the adsorber, 9227 kg/h of extract are adsorbed at 3 bar and 40° C. and/or stored in the gaseous interstitial volume of the adsorber particles. The example is calculated with 14% H2 losses, as stated in Syed Naqvi, “Hydro-gen Production,” PEP Report 32C, SRI Consulting, September 2007. This means that 163 kg/h of hydrogen are lost as flushing losses and 1000 kg/h of hydro-gen leave the adsorber as a product stream. Heat is released during the ad-sorption. The warm product stream has a temperature of 59° C. and is cooled to 40° C. in the product cooler. This requires a heat transfer capacity of 75 KW.

The extract stream from the adsorber contains 25.3 vol. % H2, 9.8 vol. % CO and 53.8 vol. % CO2, 11.0 vol. % H2O and 0.1 vol. % MeOH.

In the desorption step, the extract stream is taken up by a heated air stream and then, after compression, burned in the burner.

This requires 100564 kg/h of air, which is first heated to 28° C. in the product cooler or air heater and then heated to 134° C. in the exhaust gas cooler before entering the desorber to take up the extract. The air loaded with the extract leaves the desorber as tail gas in an amount of 109,791 kg/h and with a composition of 2.1 vol. % H2, 19.2 vol. % O2, 72.5 vol. % N2, 0.8 vol. % CO and 4.5 vol. % CO2, 0.9 vol. % H2O and 0.01 vol. % MeOH.

The desorption step requires heat. Therefore, the temperature in the desorber drops to 122° C.

To overcome all stream losses, the tail gas is compressed to 1.2 bar in an air conveying element. The calculations are based on a mechanical efficiency of 90% and an isentropic efficiency of 75%. The compression requires 962 KW of electrical output. During compression, the temperature of the tail gas increases from 122° C. to 149° C.

In a burner, the compressed tail gas is burned together with 1 kg/h of control stream from the evaporator. This produces a hot combustion gas with a temperature of 395° C. This combustion gas is fed into the reformer, where it provides a thermal output of 3750 KW for the reforming reaction and the heating of the gaseous reformer feed from 230 to 250° C.

The warm combustion gas from the reformer has a temperature of 281° C. and is cooled to 154° C. in the evaporator before being further cooled to the exhaust gas temperature of 58° C. in counterflow to the fed ambient air.

The energetic efficiency of the overall process En, tot is therefore

$${η}_{EN , tot} = 1 - Δ {E}_{V , tot} / {E}_{F} = 1 - ( Δ {E}_{V , chem} + ΣΔ {P}_{V} ) / {E}_{F} = 1 - [ ( 36053 - 33320 ) + 962 ] / 36053 = 0.898 .$$

The chemical conversion losses ΔE_{V,chem} are calculated as:

$$Δ {E}_{V , chem} = {E}_{V , H2} + {E}_{V , AG} + Σ {Q}_{V} - ( - {m}_{H2O} * Δ {H}_{V , H2O} ) - Σ {P}_{net} = 60 + 1018 + 0 + 2521 - 0.9 * 962 = 2733 kW$$

$$Δ {E}_{V , tot} = Δ {E}_{V , chem} + Σ {P}_{gross} = 2733 + 962 = 3695 kW$$

From this, we can calculate the energy efficiency of the overall process:

$${η}_{EN , tot} = 1 - Δ {E}_{V , tot} / {E}_{F} = 1 - 3695 / 36053 = 0.898$$

The H2 product mass flow m_{H2} and its related specific total conversion losses ΔE_{V,spec} then can be expressed as:

$$Δ {E}_{V , spec} = Δ {E}_{V , tot} / {m}_{H2} = 3695 kWh / kg H 2$$

The total energy efficiency without taking into account heat losses through the apparatus walls is η_{EN, tot}=90.0%.

### Second Example—Ammonia

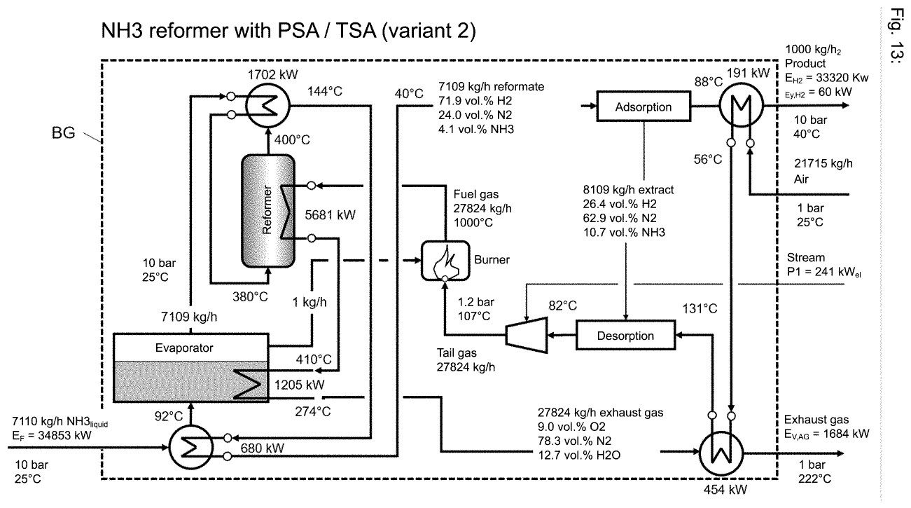

The example according to variant 2 is shown in FIG. 13:

The example is the result of a thermodynamic simulation with regard to amounts and energies using a BASF internal simulator similar to the simulation program Aspen Plus.

The example is calculated without heat losses through the method apparatus walls.

According to the method according to the invention, 7110 kg of liquid ammonia with a temperature of 25° C. and a pressure of 10 bar must be fed into the method per hour.

With countercurrent flow of the liquid ammonia and the warm reformate in the second reformate cooler, the liquid ammonia is preheated to 92° C. and the reformate is cooled to the adsorption temperature of 40° C. This requires a heat transfer capacity of 680 KW. The liquid ammonia has a boiling point of 25° C. at 10 bar. 7109 kg of ammonia vapor are fed to the reformer as the reformer feed, and 1 kg/h are fed to the burner as a control stream.

In the reformer, the ammonia vapor is brought to the reaction temperature of 400° C. and catalytically reformed to 71.9 vol. % H2, 24.0 vol. % N2. The NH3 equilibrium conversion at 400° C. and 10 bar is theoretically 92%. The reformate additionally contains 4.1 vol. % of unconverted NH3. 5681 KW of thermal energy is required for reforming.

The reformate is then cooled down in the first reformate cooler to 144° C. In return, the vaporous raw condensate is heated from 25° C. to 380° C. The heating requires 1702 KW of thermal output.

In the adsorber, 6109 kg/h of extract are adsorbed at 10 bar and 40° C. or stored in the gaseous interstitial volume of the adsorber particles. The example is calculated with 14% H2 losses, as stated in Syed Naqvi, “Hydro-gen Production,” PEP Report 32C, SRI Consulting, September 2007. This means that 163 kg/h of hydrogen are lost as flushing losses and 1000 kg/h of hydro-gen leave the adsorber as a product stream. Heat is released during the ad-sorption. The warm product stream has a temperature of 88° C. and is cooled to 40° C. in the product cooler. This requires a heat transfer capacity of 191 kW.

The extract stream from the adsorber contains 26.4 vol. % H2, 62.9 vol. % N2 and 10.7 vol. % NH3.

In the desorption step, the extract stream is taken up by a heated air stream and then, after compression, burned in the burner.

This requires 21715 kg/h of air, which is first heated to 56° C. in the product cooler or air heater and then heated to 131° C. in the exhaust gas cooler before entering the desorber to take up the extract. The air loaded with the extract leaves the desorber as tail gas in an amount of 27,824 kg/h and with a composition of 7.6 vol. % H2, 14.9 vol. % O2, 74.4 vol. % N2, 3.1 vol. % NH3.

The desorption step requires heat. Therefore, the temperature in the desorber drops to 82° C.

To overcome all stream losses, the tail gas is compressed to 1.2 bar in an air conveying element. The calculations are based on a mechanical efficiency of 90% and an isentropic efficiency of 75%. The compression requires 241 KW of electrical output. During compression, the temperature of the tail gas increases from 82° C. to 107° C.

In a burner, the compressed tail gas is burned together with 1 kg/h of control stream from the evaporator. This produces a hot combustion gas with a temperature of 1000° C. This combustion gas is fed into the reformer, where it provides a thermal output of 5681 KW for the reforming reaction and the heating of the gaseous reformer feed from 380 to 400° C.

The warm combustion gas from the reformer has a temperature of 410° C. and is cooled to 274° C. in the evaporator before being further cooled to the exhaust gas temperature of 222° C. in counterflow to the fed ambient air.

The energetic efficiency of the overall process En, tot is therefore

$${η}_{EN , tot} = 1 - Δ {E}_{V , tot} / {E}_{F} = 1 - ( Δ {E}_{V , chem} + ΣΔ {P}_{V} ) / {E}_{F} = 1 - [ ( 34853 - 33320 ) + 241 ] / 34853 = 0.949 .$$

The chemical conversion losses ΔE_{V,chem} are calculated as:

$$Δ {E}_{V , chem} = {E}_{V , H2} + {E}_{V , AG} + {ΣQ}_{V} - ( - {m}_{H2O} * Δ {H}_{V , H2O} ) - Σ {P}_{net} = 60 + 1684 + 0 + 0 = 0.9 * 241 = 1527 kW$$

$$Δ {E}_{V , tot} = Δ {E}_{V , chem} + Σ {P}_{gross} = 1527 + 241 = 1768 kW$$

From this, we can calculate the energy efficiency of the overall process:

$${η}_{EN , tot} = 1 - Δ {E}_{V , tot} / {E}_{F} = 1 - 1768 / 34853 = 0.949$$

The H2 product mass flow m_{H2} and its related specific total conversion losses ΔE_{V,spec} then can be expressed as:

$$Δ {E}_{V , spec} = Δ {E}_{V , tot} / {m}_{H2} = 1768 kWh / kg H 2$$

The total energy efficiency without taking into account the heat losses through the apparatus walls is η_{EN, tot}=94.9%.

### Variants:

There are multiple options for heat integration. What they all have in common is that the combustion gas from the burner is passed in the first step through the heat exchanger in the reformer (A4) and in the second step through the heat exchanger in the evaporator (A2).

In variant 1 (FIG. 4), the evaporated feedstocks are heated in the first reformate cooler before entering the reformer, and the warm reformate is cooled in the second reformate cooler by heating the preheated air. The residual cooling of the combustion gas is achieved by preheating the feed stream.

In variant 2 (FIG. 5), as in variant 1, the evaporated feedstocks are heated in the first reformate cooler before entering the reformer. However, the warm reformate is not cooled by the heated air, but rather by the incoming liquid feedstocks. The residual cooling of the cooled combustion gas after the evaporator is achieved by heating the heated air.

In variant 3 (FIG. 6), the evaporator serves as the first reformate cooler, the air is heated in the second reformate cooler before entering the desorber, and the warm combustion gas is cooled to the exhaust gas temperature in the feed preheater before leaving the method.

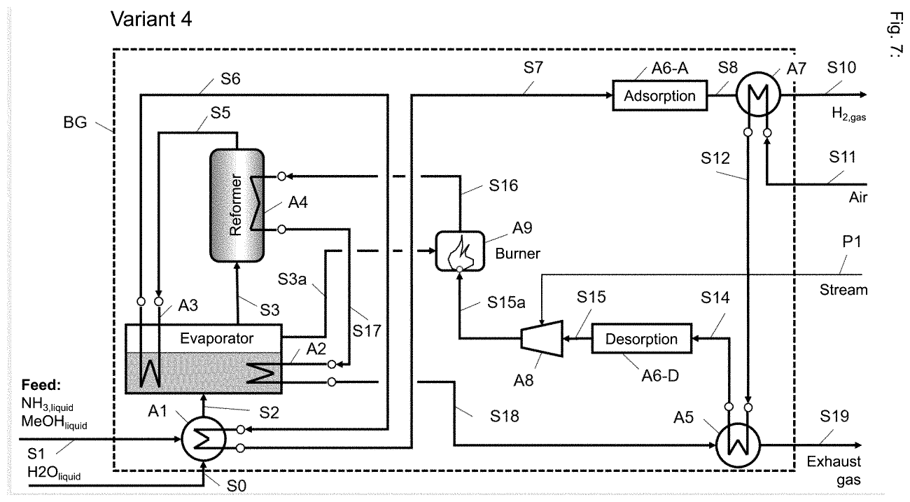

In variant 4 (FIG. 7), as in variant 3, the evaporator serves as the first reformate cooler, and the air is heated in the second reformate cooler before entering the desorber. As in variant 2, the warm reformate is cooled by the incoming liquid feedstocks. The residual cooling of the cooled combustion gas after the evaporator is achieved by heating the heated air.

Table 7 compares the results for the individual variants.

The designations should be read as follows: MeOH-2 means, for example, variant 2 for the case using methanol. Variant NH3-1 means variant 1 for the case using ammonia. NH3-2-00 refers to variant 2 for ammonia as an energy carrier in the case where the temperature differences between the hot and cold streams in the heat exchangers are zero. However, this would require infinitely large heat exchanger surfaces. Therefore, this variant with an overall efficiency η_{en,tot} of 98.1% represents the theoretical limit.

If H2 losses via the tail gas are higher, the gas mixture in the desorber may be explosive. In this case, it is advisable to recirculate part of the exhaust gas into the desorber using a cycle gas compressor (variant NH3-2-CG, FIG. 14).

The influence of H2 losses via the tail gas on the overall efficiency ηen, tot was also investigated. In the basic case, 14% H2 loss is assumed. The cases were also calculated for 5%, 8% and 11%. While the reduction from 14 to 11% H2 loss still results in a significant increase in overall efficiency from 94.9% to 97.1%, a further reduction hardly improves the overall efficiency.

An important result of these model calculations is therefore the use in-struction to reduce the H2 loss via the tail gas to approximately 11%, which is possible with the method according to the invention, since here the desorption is not carried out by applying a negative pressure as described in the prior art, but rather an unloaded gas stream (cycle gas or combustion air) can be used to reduce the partial pressure of the extract substances in the gas phase (tail gas).

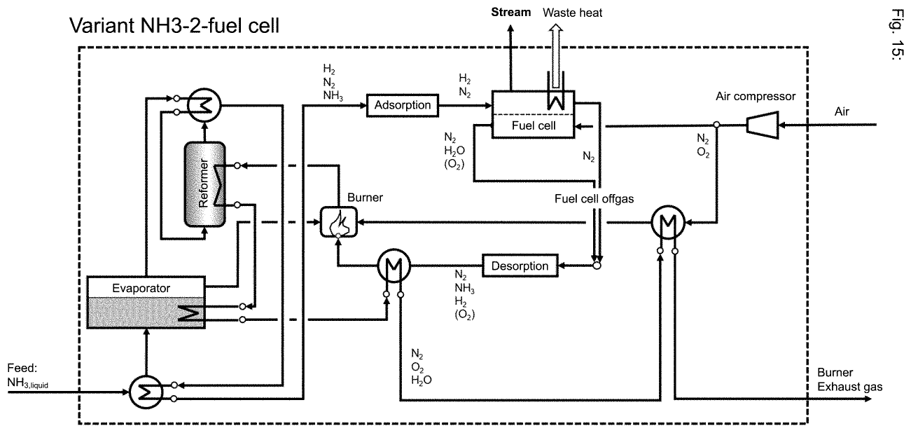

The combination of the method according to the invention with a fuel cell (FC) for electricity generation results in advantages. This will be explained using the ammonia case (see variant NH3-2-fuel cell, FIG. 15):
In case the fuel cell is not operated with pure H2, but rather with a mixture of H2 and N2, the driving potential for electricity generation is reduced—at the same pressure. However, this can be compensated for by a 25% pressure increase. The associated lower NH3 conversion in the reformer is not important in this method, since the unconverted NH3 is converted into heat in the burner, which is necessary for the operation of the reforming and evaporation.
The adsorption effort is reduced considerably, since the separation of NH3 from H2-containing gases requires much less effort than the separation of N2 and H2. The reason for this is that the boiling point difference between NH3 and H2 is much larger than between N2 and H2. In addition, the alkaline effect of NH3 can be used very well.
The difficult separation of H2 and N2 occurs naturally in the fuel cell via the membrane, which is only permeable to H+ ions.
Since the exhaust gases from the fuel cell are almost oxygen-free, they are particularly suitable for desorption. In this case, no cycle gas is required to prevent explosive concentrations.
Instead of two air compressors, one for the method according to the invention and one for the fuel cell, only one air compressor is needed. A larger air compressor is always more cost-effective than two small ones. In addition, the efficiency increases with the size of a compressor.
The use of the exhaust gas streams from the fuel cell as flushing gas in the desorption also improves the efficiency. At 95.2%, it is higher than the efficiency of variants with the same heat integration. In comparison, variant NH3-2 achieves an efficiency of 94.9%- and the cycle gas variant NH3-2-CG an efficiency of 94.8%.

TABLE 7
Comparison of the variants for an H2 product stream of 1 kg/h. The enthalpy of the H2 product stream H2 = 33.32 kW

| | | | Streams | | | Powers | | | | | |
|---|---|---|---|---|---|---|---|---|---|---|---|
| | H2 loss | Exhaust gas | Feed | Water | Exhaust | Feed | Water | Exhaust | Gross | Σ Conversion | Overall |
| | via tail | temperature | S1 | S0 | gas S19 | E_{F} | E_{H2O, liquid} | gas E_{EG} | electricity P1 | losses ΔE_{V, tot} | efficiency |
| Variants | gas | T_{EG} | kg/h | | | kW | | | | | η_{EN, tot} |
| MeOH-2 | 14% | 58° C. | 6.51 | 3.72 | 109.79 | 36.05 | −2.52 | 1.02 | 0.96 | 3.70 | 90.0% |
| MeOH-1 | 14% | 100° C. | 6.56 | 3.63 | 37.60 | 36.36 | −2.46 | 0.81 | 0.32 | 3.37 | 90.8% |
| MeOH-1 | 11% | 97° C. | 6.49 | 3.12 | 35.32 | 35.94 | −2.11 | 0.72 | 0.30 | 2.92 | 91.9% |
| NH3-1 | 14% | 226° C. | 7.17 | 0.00 | 30.77 | 35.14 | 0.00 | 1.88 | 0.30 | 2.13 | 94.0% |
| NH3-3 | 14% | 255° C. | 7.29 | 0.00 | 37.25 | 35.74 | 0.00 | 2.61 | 0.44 | 2.86 | 92.1% |
| NH3-4 | 14% | 178° C. | 7.11 | 0.00 | 48.49 | 34.85 | 0.00 | 2.20 | 0.81 | 2.34 | 93.4% |
| NH3-2 | 14% | 221° C. | 7.11 | 0.00 | 28.31 | 34.85 | 0.00 | 1.70 | 0.25 | 1.79 | 94.9% |
| NH3-2- | 14% | 313° C. | 7.11 | 0.00 | 19.01 | 34.85 | 0.00 | 1.75 | 0.31 | 1.84 | 94.8% |
| CG | | | | | | | | | | | |
| NH3-2- | 14% | 194° C. | 7.11 | 0.00 | 25,616 | 34.85 | 0.00 | 1.59 | 013 | 1.67 | 95.2% |
| fuel cell | | | | | | | | | | | |
| NH3-2 | 11% | 133° C. | 6.94 | 0.00 | 27.56 | 34.01 | 0.00 | 0.90 | 0.30 | 0.99 | 97.1% |
| NH3-2 | 8% | 132° C. | 6.94 | 0.00 | 26.59 | 34.00 | 0.00 | 0.87 | 0.28 | 0.96 | 97.2% |
| NH3-2 | 5% | 132° C. | 6.93 | 0.00 | 25.69 | 33.98 | 0.00 | 0.84 | 0.26 | 0.92 | 97.3% |
| NH3-2-00 | 5% | 110° C. | 6.88 | 0.00 | 24.38 | 33.74 | 0.00 | 0.63 | 0.24 | 0.66 | 98.1% |

Comparison of the NH3-2 Variant with the Prior Art:

A comparison of the energy efficiency of the method according to the invention with the prior art provides an overview of the energetic and thus economic advantages of the invention:
GB 1,079,660 65%
WO 2018/235059 A1<78%
L. Lin et al. <80%
WO 02/071451 A2 85%
Lamb et al. 90%
EP 3,028,990 >90% (product in this case is only a gas mixture of H2/N2/NH3)
Invention 94 to 97%

The method according to the invention for producing pure hydrogen has the highest energy efficiency.

1. A method for obtaining hydrogen from methanol or ammonia, wherein, in a first step, methanol or ammonia is evaporated and in a second step the methanol or ammonia is reformed to a hydrogen-containing gas mixture; in a third step, the gaseous reformate is cooled to 25 to 100° C., and in a fourth step the hydrogen is separated from the cooled gaseous reformate by means of a sorption process at a pressure of 1 to 60 bar and at a temperature of 25 to 100° C., wherein, in a fifth step, in parallel with the first four steps air is compressed and preheated with the separated hydrogen after the sorption process, in a sixth step the adsorbent loaded with the extract is regenerated using the preheated air, and in a seventh step the extract separated from the adsorbent is combusted with the air, wherein the combustion gases are passed in the direction of flow of the combustion gases through at least two different heat exchangers in order to (i) first provide the reaction heat for reforming the methanol or the ammonia, and (ii) subsequently provide the evaporation heat for evaporating the reformer feed.

2. The method according to claim 1, wherein the seventh step, the desorption, is carried out at temperatures between 8° and 500° C. and at a pressure between 0.5 and 3 bar.

3. The method according to claim 1, wherein the reforming step is carried out at 180 to 350° C. in the case of methanol and at 300 to 500° C. in the case of ammonia.

4. The method according to claim 1, wherein the reformate further heats the preheated air in a heat exchanger before it enters the sorption step.

5. The method according to claim 1, wherein the combustion gases subsequently further heat the preheated air as step (iii).

6. The method according to claim 1, wherein the reformate preheats the feed prior to the evaporator in a heat exchanger before it enters the sorption step.

7. The method according to claim 6, wherein the combustion gases are passed through at least three different heat exchangers in the direction of flow of the combustion gases in order to (i) first provide the reaction heat for reforming the methanol or ammonia, (ii) then provide the evaporation heat for evaporating the reformer feed, and (iii) finally preheat the air for the regeneration.

8. The method according to claim 1, wherein the combustion gases are passed through at least three different heat exchangers in the direction of flow of the combustion gases in order to (i) first provide the reaction heat for reforming the methanol or ammonia, (ii) then provide the evaporation heat for evaporating the reformer feed, and (iii) finally preheat the feed upstream of the evaporator.

9. The method according to claim 8, wherein the reformate provides additional evaporation heat for evaporating the reformer feed in a heat exchanger before it enters the sorption step.

10. The method according to claim 1, wherein the reformate provides additional evaporation heat for evaporating the reformer feed in a heat exchanger before it enters the sorption step, and preheats the feed before the evaporator in a further heat exchanger.

11. The method according to claim 10, wherein the combustion gases are passed through at least three different heat exchangers in the direction of flow of the combustion gases in order to (i) first provide the reaction heat for reforming the methanol or ammonia, (ii) then provide the evaporation heat for evaporating the reformer feed, and (iii) finally further heat the preheated air.

12. The method for producing electricity from methanol or ammonia, wherein methanol or ammonia is evaporated in a first step, reformed in a second step to a hydrogen-containing gas mixture, in a third step the gaseous reformate is cooled to 25 to 200° C., in a fourth step the hydrogen and, in the case of ammonia, together with the nitrogen, are separated from the cooled gaseous reformate at a pressure of 1 to 60 bar and a temperature of 25 to 200° C. by a sorption process, and further electricity is produced from the separated hydrogen in a fuel cell, wherein, in parallel to the first steps, air is compressed and preheated in a fifth step, in a sixth step the adsorbent loaded with the extract is regenerated with the offgases from the anode and/or cathode side of the fuel cell, and in a seventh step the extract separated from the adsorbent is combusted with the air, wherein the combustion gases are passed through at least three different heat exchangers in the direction of flow of the combustion gases in order to (i) first provide the reaction heat for reforming the methanol or ammonia and to (ii) then provide the evaporation heat for evaporating the reformer feed, and finally to (iii) preheat the air and/or the extract separated from the adsorbent.

13. The method according to claim 12, wherein ammonia is used as the feed.

14. The method according to claim 12, wherein in the sixth step the adsorbent loaded with the extract is regenerated with the offgases of the anode and cathode sides of the fuel cell.

15. The method according to claim 12, wherein the reformate preheats the feed before the evaporator and/or the reformer feed after the evaporator in a heat exchanger before it enters the sorption step.
